(19) United States
(12) Patent Application Publication
(10) Pub. No.: US 2014/0022572 A1
(43) Pub. Date: Jan. 23, 2014

(54) METHOD AND SYSTEM FOR ASSIGNING FILENAME TO DIGITAL IMAGE

(71) Applicant: John R. Washington, Hitchin (GB)

(72) Inventor: John R. Washington, Hitchin (GB)

(73) Assignee: XEROX CORPORATION, Norwalk, CT (US)

(21) Appl. No.: 13/550,645

(22) Filed: Jul. 17, 2012

(51) Int. Cl. G06F 15/00; G06K 9/54

(52) U.S. Cl. 358/1.13; 382/305

(57) ABSTRACT

Method, system, and computer program product for naming a digital image are disclosed. One or more descriptors from the digital image are identified based on at least one of the one or more text fields or a machine-readable code in the digital image. The one or more descriptors include at least one of information on a subject matter in the digital image or user-related information in the digital image. A filename is then assigned to the digital image based on the identified one or more descriptors.

### TECHNICAL FIELD

The presently disclosed embodiments are related to electronic documents. More particularly, the presently disclosed embodiments are related to a technique for automatically naming digital images.

### BACKGROUND

Scan to email functionality is currently inadequate to deal with large workflow scanning jobs. For example, in a school environment, teachers mark students' examination papers and then return the examined papers to the students via email. However, this requires each paper to be scanned individually and then received in the teacher's email inbox as an email with a default subject, such as, “Scan from a WorkCentre” with an attachment (e.g., a scanned copy of the examined paper) with a default filename, such as, “doc.pdf”. Thereafter, multiple such attachments need to be sorted and renamed manually by the teachers. Further, the subject of each of the emails also requires to be manually modified by the teachers. This exercise is time-intensive and is prone to errors.

### SUMMARY

According to embodiments illustrated herein, there is provided a method for naming a digital image. The method is implementable on a computing device. The method includes identifying one or more descriptors from the digital image based on at least one of one or more text fields or a machine-readable code in the digital image. The one or more descriptors include at least one of information on a subject matter in the digital image or user-related information in the digital image. A filename is then assigned to the digital image based on the identified one or more descriptors.

According to embodiments illustrated herein, there is provided a multifunction device (MFD). The MFD includes an image-scanning module, a descriptor identification module, a filename module, and a communication module. The image-scanning module is configured for generating a digital image from a document. The descriptor identification module is configured for identifying one or more descriptors from the digital image based on at least one of one or more text fields or a machine-readable code in the digital image. The one or more descriptors comprise at least one of information on the subject matter in the digital image or user-related information in the digital image. The filename module is configured for assigning a filename to the digital image based on the one or more descriptors. The communication module is configured for composing a message comprising the digital image and a subject, wherein the subject is determinable based on the one or more descriptors. The communication module then sends the message to one or more recipients.

According to embodiments illustrated herein, there is provided a computer program product for use with a computer. The computer program product comprises a computer-usable data carrier storing a computer-readable program code embodied therein for communicating a digital image scanned by a multifunction device (MFD). The computer-readable program code comprises a program instruction means for identifying one or more descriptors from the digital image based on at least one of one or more text fields or a machine-readable code in the digital image. The computer-readable program code comprises a program instruction means for assigning a filename to the digital image based on the one or more descriptors. The computer-readable program code comprises a program instruction means for sending a message comprising the digital image to one or more recipients.

### BRIEF DESCRIPTION OF DRAWINGS

The accompanying drawings illustrate various embodiments of systems, methods, and embodiments of various other aspects of the invention. Any person having ordinary skills in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating an environment in accordance with at least one embodiment;

FIG. 2a depicts a layout of a digital image in accordance with at least one embodiment;

FIG. 2b depicts a layout of another digital image in accordance with at least one embodiment;

FIG. 3 is a block diagram illustrating a computing device in accordance with at least one embodiment;

FIG. 4 is a flow diagram illustrating a method for assigning a filename to a digital image in accordance with at least one embodiment; and

FIGS. 5a, 5b, and 5c is a flow diagram illustrating a method for assigning a filename to a digital image in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “machine-readable code” (MRC) refers to an electronic code that can be read by an electronic machine. Examples of the machine-readable code include, but are not limited to, a one-dimensional barcode, such as a Universal Product Code (UPC), or a two-dimensional bar code, such as a Quick Response (QR) code, a High Capacity Color Barcode, or a MaxiCode.

A “multifunction device” (MFD) refers to a device that can perform multiple functions. Examples of the functions include, but are not limited to, printing, scanning, copying, faxing, emailing, and the like.

A “digital image” refers to a collection of data, including image data in any format, retained in an electronic form. The digital image can contain one or more pictures, symbols, text, blank or non-printed regions, margins, etc. In an embodiment, examples of the digital image include, but are not limited to, various bank account forms, an e-ticket, a hotel reservation form, a boarding pass, student examination papers, various insurance forms, e-statements corresponding to banking, and credit cards. In an embodiment, the digital image is obtained by scanning a corresponding physical document. The digital image can be stored in various file formats, such as, JPG or JPEG, GIF, TIFF, PNG, BMP, RAW, PSD, PSP, PDF, and the like.

A “computing device” refers to a computer, a device including a processor/microcontroller and/or any other electronic component, device or system that performs one or more operations according to one or more programming instructions. Examples of the computational device include, but are not limited to, a desktop computer, a laptop, a personal digital assistant (PDA), a smartphone, an MFD, and the like. The computational device is capable of accessing (or being accessed over) a network (e.g., using wired or wireless communication capabilities).

A “network” refers to a medium that interconnects a survey management server and various computational devices. Examples of the network include, but are not limited to, LAN, WLAN, MAN, WAN, and the Internet. Communication over the network may be performed in accordance with various communication protocols such as Transmission Control Protocol and Internet Protocol (TCP/IP), User Datagram Protocol (UDP), and IEEE 802.11n communication protocols.

“Scanning” refers to a technique of recording an image as digital data in any format, thereby creating a file.

A “descriptor” refers to information contained in text fields or information derived from the information contained in the text fields. Descriptors are identified from the text fields including, but not limited to, various user-related information fields and various subject matter related fields, such as, title field, and content field.

A “message” refers to any arrangement whereby digital data relating to images and/or text is conveyed to at least one recipient. Various examples of the message include, but are not limited to, e-mail, multimedia message (MMS), FAX, or any customizable electronic media capable of conveying images and/or text.

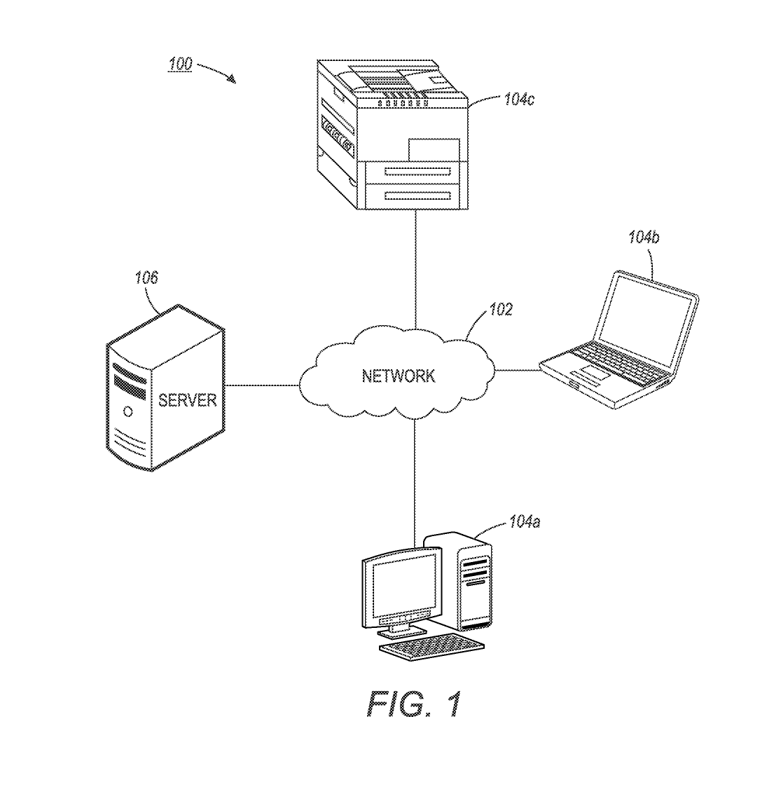

FIG. 1 is a block diagram illustrating an environment 100 in accordance with at least one embodiment. Various embodiments of the methods and systems for determining filenames for digital images can be implemented in the environment 100. The environment 100 includes a network 102. The environment 100 further includes a desktop computer 104a, a laptop 104b, an MFD 104c (hereinafter referred to as computing device 104), and a server 106.

A user operating the desktop computer 104a or the laptop 104b is capable of accessing the MFD 104c and/or the server 106 through the network 102. A functionality of automatically assigning filenames to digital images can be implemented on at least one of the desktop computer 104a, the laptop 104b, the MFD 104c, and the server 106. In an embodiment, for example, the desktop computer 104a and/or the laptop 104b are capable of executing an application for determining the filenames of the digital images. In another embodiment, the application is hosted by the server 106 and the desktop computer 104a and/or the laptop 104b are capable of accessing the application over the network 102. In another embodiment, the MFD 104c is adapted to determine and assign the filenames of the scanned documents (e.g., digital images). The MFD 104c then communicates the scanned documents with the assigned filenames to one or more recipients.

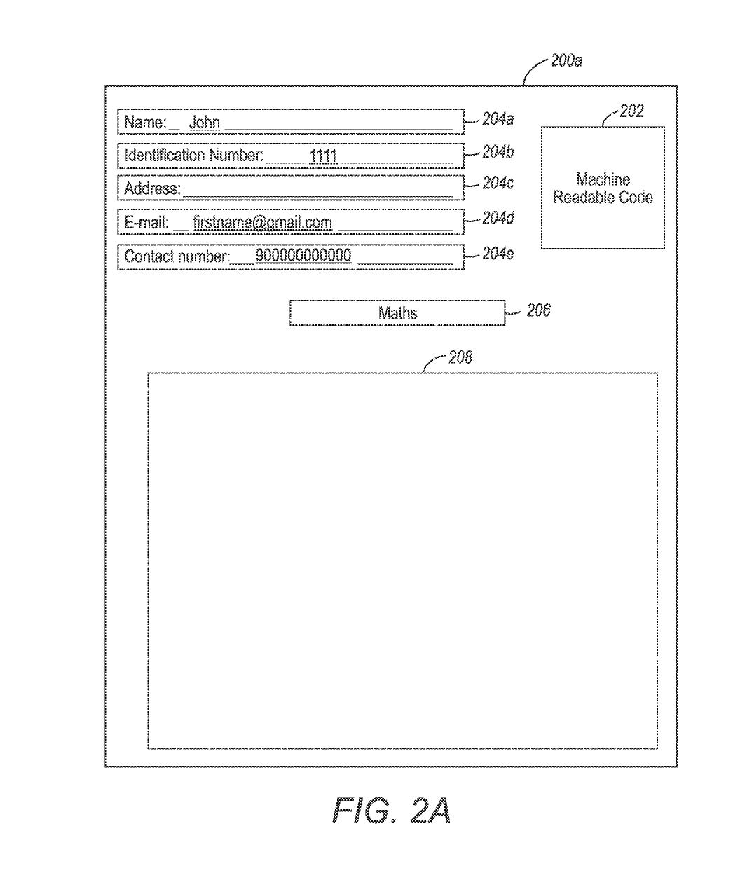

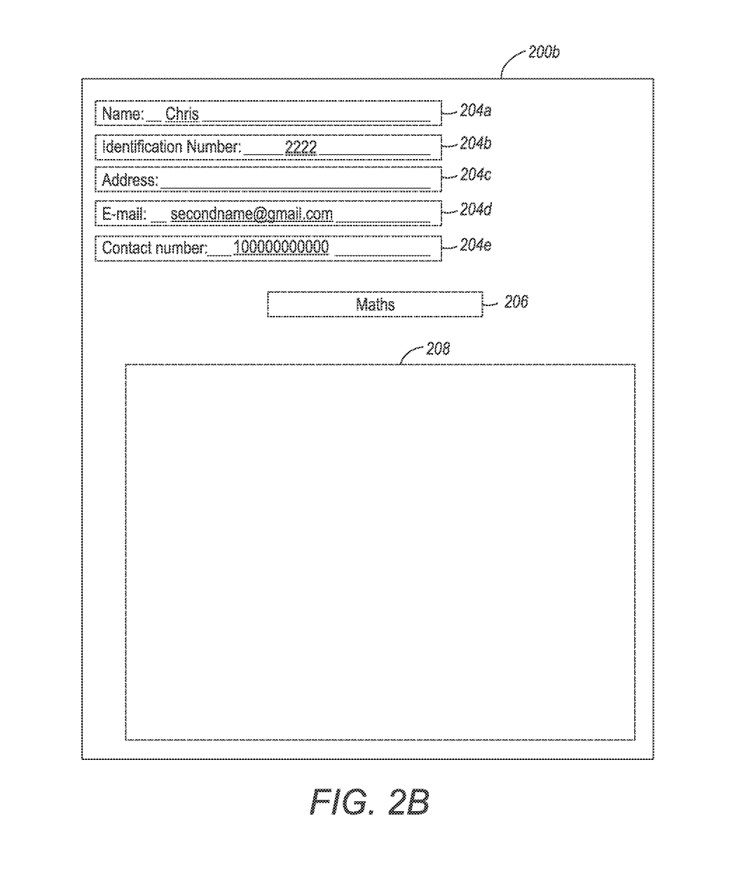

FIG. 2a depicts layout of a digital image 200a in accordance with at least one embodiment. The layout of the digital image 200a includes an MRC field 202, various text fields 204a, 204b, 204c, 204d, and 204e (hereinafter referred to as user-related information fields 204) and subject matter related fields, such as, a title field 206 and a content field 208.

The MRC field 202 contains an MRC. The user-related information fields 204 contain information such as name, identification number, address, email address, contact number, FAX number, and so forth. The title field 206 contains a suitable title for content in the digital image. The content field 208 contains various details including, but not limited to, various text, symbols, pictures, and so forth. Further, the ongoing description is not limited with respect to the content in the content field 208.

The positions of the various fields, such as, the user-related information fields 204, the MRC field 202, the title field 206, and the content field 208, may vary in different digital images without departing from the scope of the ongoing description. Further, it is understood by a person having ordinary skills in the art that all of the aforementioned fields may not appear together in other digital images. Also, there can be more fields, other than those depicted in the digital image 200a, present in any digital image. For example, in an embodiment, the MRC field 202 may not be present in some digital images or there can be a fewer number of user-related information fields on other digital images.

FIG. 2b depicts a layout of another digital image 200b in accordance with at least one embodiment. It is depicted that the MRC field 202 is not present in the digital image 200b.

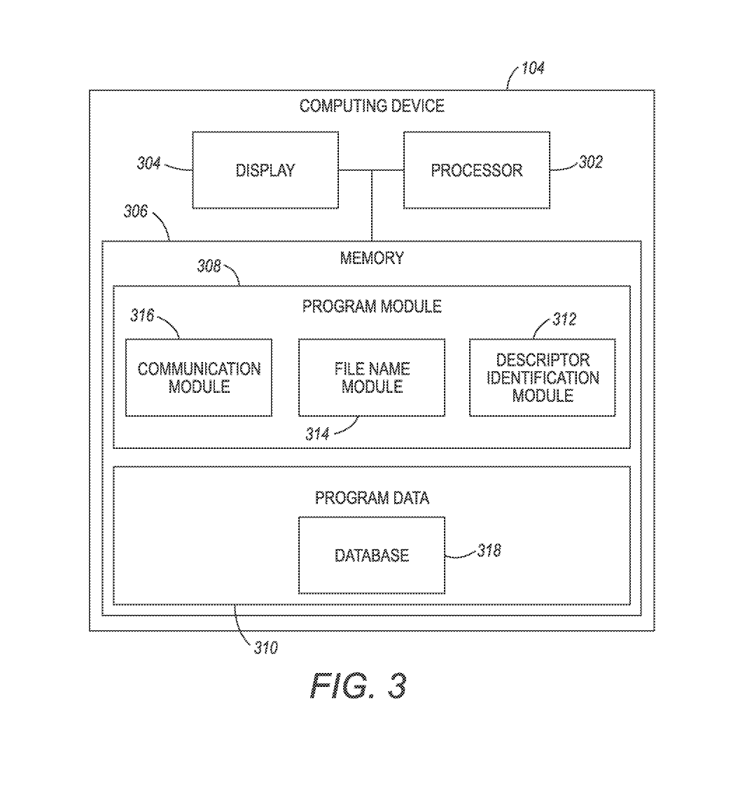

FIG. 3 is a block diagram illustrating a computing device 104 (such as, the desktop computer 104a, the laptop 104b, or the MFD 104c) in accordance with at least one embodiment. The computing device 104 includes a processor 302, a display 304, and a memory 306. The memory 306 includes a program module 308 and a program data 310. The program module 308 includes an image-scanning module 311, a descriptor identification module 312, a filename module 314, and a communication module 316. The program data 310 includes a database 318. In an embodiment, the memory 306 and the image-scanning module 311 function under the control of the processor 302.

The processor 302 is coupled to the display 304, one or more input mediums (not shown), and the memory 306. The processor 302 executes a set of instructions stored in the memory 306 to perform one or more operations on the computing device 104. The processor 302 can be realized through a number of processor technologies known in the art. Examples of the processor 302 include be, but are not limited to, X86 processor, RISC processor, ASIC processor, CISC processor, or any other processor. In an embodiment, the processor 302 includes a Graphics Processing Unit (GPU) that executes the set of instruction to perform one or more image processing operations.

The display 304 facilitates the user to view various information and interact with the computing device 104 in conjunction with the mediums. The display 304 can be realized through several known technologies, such as, Cathode Ray Tube (CRT) based display, Liquid Crystal Display (LCD), Light Emitting Diode (LED)-based display, Organic LED display technology, and Retina Display technology. Further, the display 304 can be a touch screen that receives a user input.

The memory 306 stores set of instructions and data. Some of the commonly known memory implementations can be, but not limited to, a random access memory (RAM), read only memory (ROM), hard disk drive (HDD), and secure digital (SD) card. The program module 308 includes a set of instructions that are executable by the processor 302 to perform specific actions on the computing device 104. It is understood by a person having ordinary skills in the art that the set of instructions stored in the memory 306 in conjunction with various hardware of the computing device 104 to perform various operations.

The image-scanning module 311 facilitates the scanning of the documents. The image-scanning module 311 facilitates the compilation of the image data captured by various image capturing units such as scanners and digital cameras to form the digital image. In an embodiment, the image capturing units implements various CCD devices and/or CMOS devices to capture the digital images. In an embodiment, the image capturing units implement a linear scanning technique. In another embodiment, the image capturing units implement a two-dimensional scanning technique. The image-scanning module 311 stores the scanned documents (e.g., digital images) in the database 318.

The descriptor identification module 312 is configured for identifying one or more descriptors from the digital image (e.g., the digital images 200a or 200b) based on at least one of the text fields, like the user-related information fields 204, the MRC field 202, the title field 206, and the content field 208. In an embodiment, the descriptors include the information contained in the text fields or information derived from the information contained in the text fields.

In an embodiment, the descriptor identification module 312 decodes the MRC contained in the MRC field 202. In order to decode the MRC, the descriptor identification module 312 implements various code decoding techniques such as various barcode decoding techniques, QR code decoding techniques, MaxiCode decoding techniques, and the like. Further, the invention is not limited with respect to the use of the decoding techniques.

In an embodiment, the descriptor identification module 312 determines the location of the text fields based on the decoded MRC. For example, the descriptor identification module 312 determines the coordinates associated with one or more of the text fields based on the decoded MRC (e.g., a QR code).

The descriptor identification module 312 recognizes the text in the text fields in order to identify one or more descriptors. For recognizing the text, the descriptor identification module 312 implements an Optical Character Recognition (OCR) technique. In an embodiment, the descriptor identification module 312 recognizes text at the locations determined on the basis of the decoded MRC. For example, the descriptor identification module 312 recognizes a student's name and roll number written in the text fields 204a and 204b respectively. Similarly, other details can also be recognized.

In an embodiment, if the digital image does not include the MRC (such as, the digital image 200b), the descriptor identification module 312 searches for various terms such as “name”, “ID”, “identification number”, “ID number”, “email”, “@”, “FAX”, and so forth, in the digital image to determine the descriptors. For example, when the descriptor identification module 312 identifies the term “name”, the descriptor identification module 312 recognizes the text written following the term “name” as student's name (i.e., as a descriptor). Similarly, other descriptors can also be determined by the descriptor identification module 312. It will be understood by a person having ordinary skill in the art that various terms defined above have been listed only as examples. Any user-defined terms can be programmed in to the system (depending on the digital image), without departing from the scope of the invention.

Once the determination of the descriptors is completed, the descriptor identification module 312 stores the descriptors in the database 318.

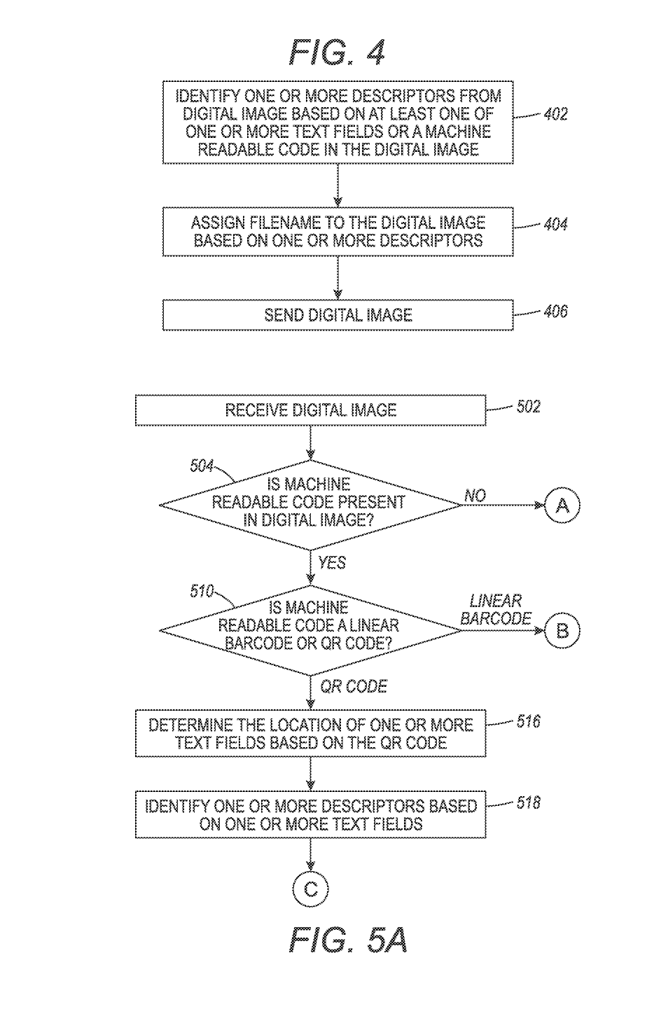

The filename module 314 is configured for assigning a filename to the digital image based on the one or more descriptors. This is further explained in conjunction with FIG. 4.

The communication module 316 facilitates the transmission of the digital image to one or more recipients. In an embodiment, the communication module 316 enables the composition of a message containing the digital image as an attachment. In an embodiment, the communication module 316 also determines the subject of the message (e.g., email, MMS, FAX, and so forth) on the basis of the descriptors. The communication module 316 then sends the message with the subject to the associated recipients. The recipients include a user who requested the digital image (e.g., a teacher who wants to forward the marked, electronic copies of answer sheets to students) and/or the one or more users associated with the email addresses or contact numbers identified from the digital image (e.g., the student who filled the examination paper that was examined by the teacher).

In an embodiment, the communication module 316 facilitates the transmission of the digital image to the one more computing device 104 such as, the desktop computer 104a and/or the laptop 104b over the network 102. In another embodiment, the communication module 316 facilitates the transmission of the digital image to the one or more computing device 104 using wired communication techniques such as USB, RS-232, or parallel wire communication. In yet another embodiment, the communication module 316 facilitates the transmission of the digital image to the one or more computing device 104 via a radio communication link such as Bluetooth, Near Field Communication (NFC), or infrared, using corresponding hardware (not shown).

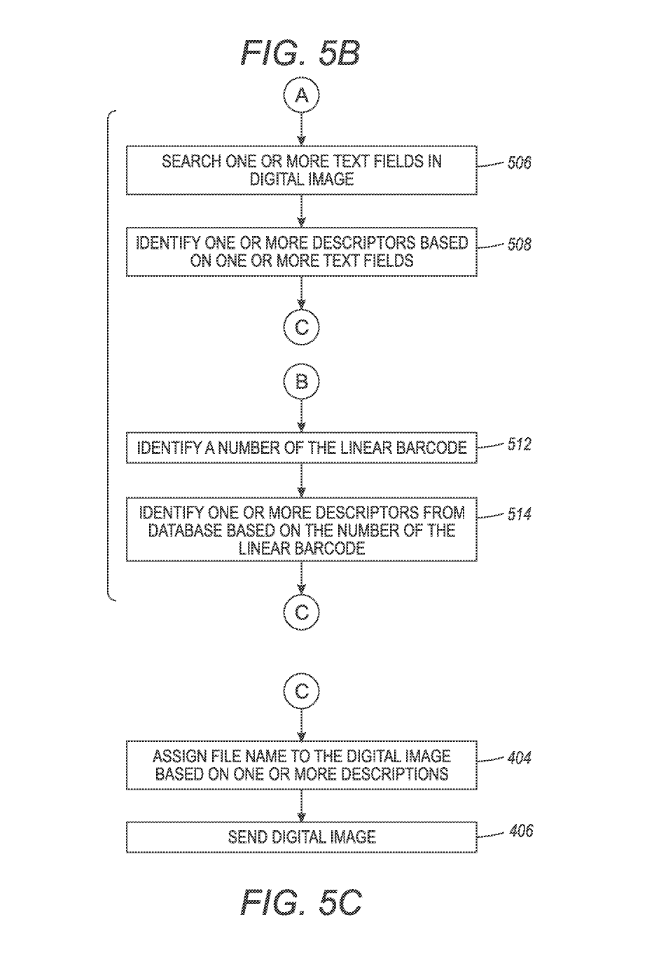

The database 318 stores the data submitted from and/or required by the image-scanning module 311, the descriptor identification module 312, the filename module 314, and the communication module 316. In an embodiment, a mapping between a value (or number) of the MRC (e.g., a barcode) and one or more user-related information is stored in the database 318. This will further be explained in conjunction with FIG. 5.

In an embodiment, the database 318 can be implemented using technologies including, but not limited to, Oracle®, IBM DB2®, Microsoft SQL Server®, Microsoft Access®, PostgreSQL®, MySQL® and SQLite®, and the like.

FIG. 4 is a flow diagram illustrating a method for assigning a filename to a digital image in accordance with at least one embodiment.

At step 402, the one or more descriptors are identified from the digital image based on at least one of the one or more text fields or the MRC in the digital image. In an embodiment, the descriptors are identified by the descriptor identification module 312. For example, from the digital image 200a, a number “1111” is identified as a descriptor from the identification number field 204b. Further, a text “John” is identified as another descriptor from the name field 204a. Further, a text “Maths” is identified as another descriptor from the title field 206. Similarly, other descriptors can also be identified from various text fields by the descriptor identification module 312. In an embodiment, as discussed earlier, various code decoding techniques can be used by the descriptor identification module 312.

At step 404, the filename is assigned to the digital image based on the identified descriptors. In an embodiment, the filename is assigned by the filename module 314. In an embodiment, for example, a filename “John-1111-Maths.pdf” is assigned to the digital image 200a. In another embodiment, for example, a filename “John-Maths.pdf” is assigned to the digital image 200a. However, any other combination or variation in the filename is also possible depending on the descriptors identified, without departing from the basic scope of the ongoing description.

In an embodiment, if the digital image does not include any text, a default filename (e.g., “scanned-document.pdf”) is assigned to the digital image.

At step 406, the digital image is sent (or communicated) to the associated one or more recipients. In an embodiment, the communication of the digital image with the assigned filename is facilitated by the communication module 316. This is further explained in conjunction with FIG. 3.

In an embodiment, if the digital image is to be sent as an attachment in an email, the subject of the email is determined by the communication module 316 based on the identified descriptors. For example, a text “John-1111-Maths” can be used as the subject line of the email. However, any other combination or variation in the text of the subject line can also be possible based on the descriptors without departing from the scope of the ongoing description. In an embodiment, if the digital image does not include any text, a default subject line (e.g., scanned-document) is determined for the email.

FIGS. 5a, 5b, and 5c are flow diagrams illustrating a method for assigning a filename to a digital image in accordance with at least one embodiment.

At step 502, a digital image is received. In an embodiment, the digital image is received by the descriptor identification module 312 from the database 318

At step 504, it is determined whether the MRC is present in the digital image or not. In an embodiment, the presence of the MRC is determined by the descriptor identification module 312. In order to check the presence of the MRC, the descriptor identification module 312 searches for the MRC in the digital image. If it is determined that the MRC is not present, step 506 is executed.

At step 506, the one or more text fields are searched in the digital image. In an embodiment, the one or more text fields are searched by the descriptor identification module 312. As discussed earlier, in an embodiment, a search for the terms, such as, “name”, “ID”, “identification number”, “ID number”, “email”, “@”, and so forth, is performed in the digital image to identify corresponding information.

At step 508, the one or more descriptors are identified based on the one or more text fields. In an embodiment, the one or more descriptors are identified by the descriptor identification module 312. This is further explained in conjunction with FIG. 3.

If it is determined that the MRC is present, a step 510 is executed. At step 510, it is checked whether the MRC is the linear barcode or a QR code. In an embodiment, the type of the MRC is determined by the descriptor identification module 312. If the MRC is a linear barcode, a step 512 is executed.

At step 512, a number of the linear barcode is identified. In an embodiment, the number of the linear barcode is identified by the descriptor identification module 312 by employing suitable barcode decoding techniques.

At step 514, one or more descriptors are identified from the database 318 on the basis of the number of the linear barcode. In an embodiment, the one or more descriptors are identified by the descriptor identification module 312. In order to identify the descriptors, the mapping (stored in the database 318) between the number of the MRC (e.g., the linear barcode) and the user-related information is referred by the descriptor identification module 312. For example, in the mapping, various numbers of the linear barcodes are mapped to the associated user-related information such as names, identification numbers, addresses, email addresses, contact numbers, and so forth. Thus, when a particular number is identified by the descriptor identification module 312, the corresponding user-related information is determined as the descriptors.

If the MRC is a QR code, then step 516 is executed by the descriptor identification module 312. At step 516, the location (e.g., the coordinates) of the one or more text fields are determined based on the QR code. Any suitable QR code decoding technique can be used by the descriptor identification module 312 to decode the QR code and determine the location of the text fields.

At step 518, the one or more descriptors are identified based on the text fields. In an embodiment, the one or more descriptors are identified by the descriptor identification module 312. This is further explained in detail in conjunction with FIG. 3 and FIG. 4.

The explanation of the linear barcode related steps and the QR code related steps is for example and any other type of MRC can also be used to identify the descriptors without limiting the scope of the ongoing description.

Once the descriptors are identified, the steps 404 and 406 are executed.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The method and systems described can also be implemented using only software programming or hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. Some of these advantages may include, but are not limited to, reduction in time and errors. Manual intervention for determining the filenames can be avoided resulting in time saving of humans. Further, the subjects of the emails are also determined atomically. Thus, large workflow scanning jobs can be possible with reduced manual intervention. For example, answer sheets/papers of all students in a class could be scanned in one batch and filenames of each scanned document can be determined. Thus, the productivity of the process of scanning many documents that subsequently need to be forwarded is improved. Further, errors can also be minimized since the filenames and subjects are automatically assigned.

Various embodiments of the methods and systems for assigning filenames to digital images have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for naming a digital image implementable on a computing device, the method comprising:
identifying one or more descriptors from the digital image based on at least one of one or more text fields or a machine-readable code in the digital image, wherein the one or more descriptors comprise at least one of information on a subject matter in the digital image or a user-related information in the digital image; and
assigning a filename to the digital image based on the identified one or more descriptors.

2. The method of claim 1 further comprising scanning a document to generate the digital image.

3. The method of claim 1 further comprising performing optical character recognition (OCR) on the digital image to identify the one or more descriptors.

4. The method of claim 1, wherein the machine-readable code comprises a barcode or a Quick Response (QR) code.

5. The method of claim 1 further comprising determining a location of the one or more text fields in the digital image based on the machine-readable code.

6. The method of claim 1, wherein the one or more text fields correspond to at least one of the information on the subject matter or the user-related information.

7. The method of claim 1, wherein the user-related information comprises at least one of an identification number, an email address, contact details, or a residence address.

8. The method of claim 7 further comprising determining a subject of an email based on the one or more descriptors.

9. The method of claim 8 further comprising sending the email to at least one of the email address or one or more predefined email addresses.

10. The method of claim 1 further comprising sending the digital image to one or more computing devices over at least one of a wired communication link or a wireless communication link.

11. A method for sending a digital image scanned by a multifunction device (MFD), the method comprising:
identifying one or more descriptors from the digital image based on at least one of one or more text fields or a machine-readable code in the digital image, wherein the one or more descriptors comprise at least one of information on the subject matter in the digital image or a user-related information in the digital image;
assigning a filename to the digital image based on the one or more descriptors; and
sending a message comprising the digital image to one or more recipients.

12. The method of claim 11 further comprising determining a subject for the message based on the one or more descriptors.

13. The method of claim 11, wherein the user-related information comprises at least one of an identification number, the email address, contact details, or a residence address.

14. A multifunction device (MFD) comprising:
an image-scanning module configured for generating a digital image from a document;
a descriptor identification module configured for identifying one or more descriptors from the digital image based on at least one of one or more text fields or a machine-readable code in the digital image, wherein the one or more descriptors comprise at least one of information on the subject matter in the digital image or a user-related information in the digital image;
a filename module configured for assigning a filename to the digital image based on the one or more descriptors; and
a communication module configured for:
composing a message comprising the digital image and a subject, wherein the subject is determinable based on the one or more descriptors; and
sending the message to one or more recipients.

15. The MFD of claim 14, wherein the descriptor identification module is further configured for determining a location of the one or more text fields based on the machine-readable code.

16. The MFD of claim 14, wherein the machine-readable code comprises a barcode or a Quick Response (QR) code.

17. The MFD of claim 14, wherein the user-related information comprises at least one of an identification number, the email address, contact details, or a residence address.

18. A computer program product for use with a computer, the computer program product comprising a computer-usable data carrier storing a computer-readable program code embodied therein for emailing a digital image scanned by a multifunction device (MFD), the computer-readable program code comprising:
a program instruction means for identifying one or more descriptors from the digital image based on at least one of one or more text fields or a machine-readable code in the digital image, wherein the one or more descriptors comprise at least one of information on the subject matter in the digital image or a user-related information in the digital image;
a program instruction means for assigning a filename to the digital image based on the one or more descriptors; and
a program instruction means for sending a message comprising the digital image to one or more recipients.

19. The computer program product of claim 18 further comprising a program instruction means for determining a subject for the email based on the one or more descriptors.

20. The computer program product of claim 18 further comprising a program instruction means for determining a location of the one or more text fields based on the machine-readable code.
